(19) United States
(12) Patent Application Publication
(10) Pub. No.: US 2021/0323470 A1
(43) Pub. Date: Oct. 21, 2021

(54) DISPLAY CONTROL DEVICE, DISPLAY CONTROL METHOD, AND STORAGE MEDIUM STORING PROGRAM

(71) Applicants: TOYOTA JIDOSHA KABUSHIKI KAISHA, Toyota-shi (JP); DENSO TEN Limited, Kobe-shi (JP)

(72) Inventors: Rio MIZUNO, Aichi-gun (JP); Kazuya OHTAKE, Toyota-shi (JP); Hiroshi MAJIMA, Kobe-shi (JP); Kazuki SASAMOTO, Chita-gun (JP)

(73) Assignees: TOYOTA JIDOSHA KABUSHIKI KAISHA, Toyota-shi (JP); DENSO TEN Limited, Kobe-shi (JP)

(21) Appl. No.: 17/226,741

(22) Filed: Apr. 9, 2021

(30) Foreign Application Priority Data
Apr. 16, 2020 (JP) 2020-073680

(51) Int. Cl. B60R 1/00; G06T 11/00; H04N 7/18; H04N 5/445

(52) U.S. Cl. CPC B60R 1/00; G06T 11/001; H04N 7/18; H04N 5/445; G08G 1/0967; B60R 2300/304; B60R 2300/607; B60R 2300/8093; B60R 2300/205

(57) ABSTRACT

A display control device includes a processor. The processor being configured to: gather a captured image from an imaging section that captures images of outside a vehicle; in a case in which an event notifiable to a driver of the vehicle has been detected based on peripheral information relating to a periphery of the vehicle, generate an interruption image including a captured image relating to the event and information indicating a direction in which the event has arisen relative to the vehicle; and perform processing to display the generated interruption image in a notification region configuring part of a display region of a display device that is visible to the driver of the vehicle.

### CROSS-REFERENCE TO RELATED APPLICATION

This application is based on and claims priority under 35 USC 119 from Japanese Patent Application No. 2020-073680 filed on Apr. 16, 2020, the disclosure of which is incorporated by reference herein.

### BACKGROUND

### Technical Field

The present disclosure relates to a display control device, a display control method, and a storage medium for controlling an image for display on a display device.

### Related Art

Japanese Patent Application Laid-Open (JP-A) No 2013-190957 discloses a surroundings monitoring device that automatically switches display of a display unit to an image captured by a camera when a clearance sonar has detected an obstacle.

Although the surroundings monitoring device of JP-A No. 2013-190957 is capable of informing the driver of the presence of an obstacle, it may be difficult for the driver to ascertain the direction of the obstacle.

### SUMMARY

An object of the present disclosure is to provide a display control device, a display control method, and a storage medium that enable a driver to easily ascertain where an event notifiable to a driver, such as the approach of an obstacle, has arisen when such an event arises.

A first aspect is a display control device including a gathering section configured to gather a captured image from an imaging section that captures images of outside a vehicle, a generation section configured to, in a case in which an event notifiable to a driver of the vehicle has been detected based on peripheral information relating to a periphery of the vehicle, generate an interruption image including a captured image relating to the event and information indicating a direction in which the event has arisen relative to the vehicle, and a processing section configured to perform processing to display the generated interruption image in a notification region configuring part of a display region of a display device that is visible to the driver of the vehicle.

In the display control device of the first aspect, the gathering section gathers the captured image captured by the imaging section, and in a case in which an event notifiable to the driver of the vehicle has been detected based on the peripheral information, the generation section generates the interruption image for display on the display device. The interruption image includes the captured image relating to the event and the information indicating the direction in which the event has arisen relative to the vehicle.

Note that “an event notifiable to a driver” may include cases in which the vehicle being driven by the driver approaches an obstacle, another vehicle, a pedestrian, or the like, cases in which the vehicle is close to straying from its lane, and cases in which a new road sign appears or a new restriction comes into effect.

Moreover, in the display control device, the processing section performs processing to display the interruption image in the notification region, this being part of the display region of the display device. In a case in which an event notifiable to a driver has arisen, the display control device notifies the driver with both the image relating to the event, and the direction in which the event has arisen. The driver is thus able to easily ascertain where the event has arisen.

A display control device of a second aspect is the display control device of the first aspect, wherein the processing section is configured to display the interruption image on the display device, so as to slide into the notification region from the direction of the event in a case in which the event has been detected based on the peripheral information.

In the display control device of the second aspect, when an event notifiable to a driver arises, processing is executed to cause the interruption image to slide into the notification region. The display control device is thus capable of intuitively communicating to the driver the fact that the event notifiable to a driver has arisen, and the direction in which this event has arisen.

A display control device of a third aspect is the display control device of the second aspect, wherein the processing section is configured to perform display on the display device, such that the interruption image being displayed in the notification region slides out toward the direction of the event in a case in which detection of the event based on the peripheral information has ended.

In the display control device of the third aspect, when the event of which the driver is being notified has ended, processing is executed such that the interruption image slides out from the notification region. The display control device is thus capable of intuitively communicating to the driver that the event notifiable to a driver has ended.

A display control device of a fourth aspect is the display control device of any one of the first aspect to the third aspect, wherein the event is an approach of an obstacle relative to the vehicle, and the interruption image includes a bird's eye vehicle image representing the vehicle and a level image indicating an approach proximity of the obstacle.

In the display control device of the fourth aspect, in cases in which the approach of an obstacle relative to the vehicle has been detected, the bird's eye vehicle image of the vehicle is displayed in the interruption image, enabling the driver to accurately ascertain the direction in which the obstacle is present relative to the vehicle. Moreover, the display control device displays the level image indicating the approach proximity of the obstacle in the interruption image, thus intuitively communicating a sense of the distance to the obstacle to the driver.

A fifth aspect is a display control method including gathering processing to gather a captured image from an imaging section that captures images of outside a vehicle, generation processing to, in a case in which an event notifiable to a driver of the vehicle has been detected based on peripheral information relating to a periphery of the vehicle, generate an interruption image including a captured image relating to the event and information indicating a direction in which the event has arisen relative to the vehicle, and interruption processing to perform processing to display the generated interruption image in a notification region configuring part of a display region of a display device that is visible to the driver of the vehicle.

In the display control method of the fifth aspect, in the gathering processing the captured image captured by the imaging section is gathered, and in a case in which an event notifiable to the driver of the vehicle has been detected based on the peripheral information, in the generation processing the interruption image for display on the display device is generated. The “interruption image” and the “event notifiable to a driver” are as described above. Moreover, in the interruption processing of this display control method, processing is performed to display the interruption image in the notification region configuring part of the display region of the display device. In a case in which an event notifiable to a driver has arisen, this display control method notifies the driver with both the image relating to the event, and the direction in which the event has arisen. The driver is thus able to easily ascertain where the event has arisen.

A sixth aspect is a non-transitory storage medium storing a program. The program causes a computer to execute processing, the processing including gathering processing to gather a captured image from an imaging section that captures images of outside a vehicle, generation processing to, in a case in which an event notifiable to a driver of the vehicle has been detected based on peripheral information relating to a periphery of the vehicle, generate an interruption image including a captured image relating to the event and information indicating a direction in which the event has arisen relative to the vehicle, and interruption processing to perform processing to display the generated interruption image in a notification region configuring part of a display region of a display device that is visible to the driver of the vehicle.

According to the program recorded in the non-transitory storage medium of the sixth aspect, a computer executes the following processing. Namely, in the gathering processing the computer gathers the captured image captured by the imaging section, and in a case in which an event notifiable to the driver of the vehicle has been detected based on the peripheral information, in the generation processing the computer generates the interruption image for display on the display device. The “interruption image” and the “event notifiable to a driver” are as described above. Moreover, in the interruption processing, the computer performs processing to display the interruption image in the notification region configuring part of the display region of the display device. In a case in which an event notifiable to a driver has arisen, the program notifies the driver with both the image relating to the event, and the direction in which the event has arisen. The driver is thus able to easily ascertain where the event has arisen.

The present disclosure enables the driver to easily ascertain where an event notifiable to a driver, such as the approach of an obstacle, has arisen when such an event arises.

### BRIEF DESCRIPTION OF THE DRAWINGS

An exemplary embodiment of the present disclosure will be described in detail based on the following figures, wherein:

FIG. 1 is a diagram illustrating an external appearance of a display system provided in a vehicle according to an exemplary embodiment;

FIG. 2 is a block diagram illustrating hardware configuration of a display system of an exemplary embodiment;

FIG. 3 is a block diagram illustrating an example of functional configuration of a CPU of a display control device of an exemplary embodiment;

FIG. 4 is a flowchart illustrating a flow of image display processing executed by a display control device of an exemplary embodiment;

FIG. 5A illustrates an example of display on a center display of an exemplary embodiment when performing normal display;

FIG. 5B illustrates an example of display on a center display of an exemplary embodiment during a fade-in;

FIG. 5C illustrates an example of display on a center display of an exemplary embodiment when displaying an interruption image; and

FIG. 5D illustrates an example of display on a center display of an exemplary embodiment during a fade-out.

### DETAILED DESCRIPTION

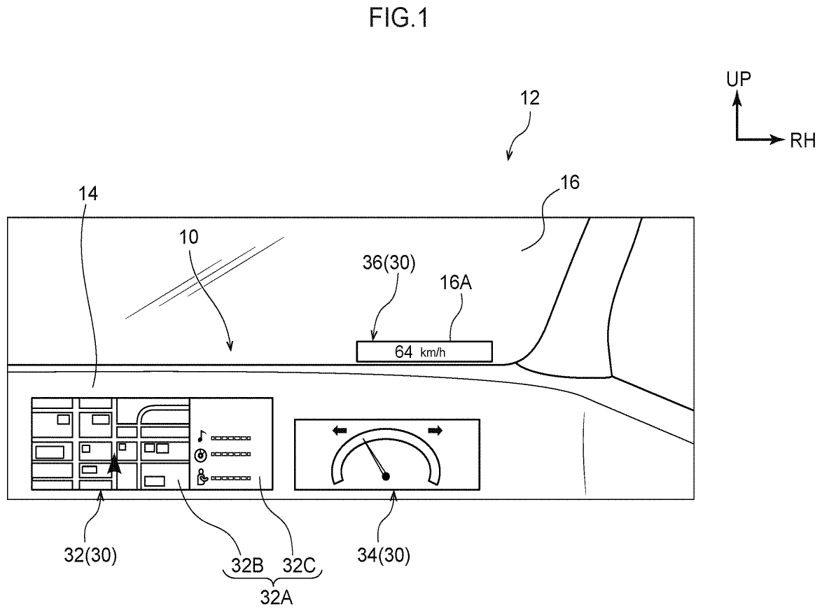

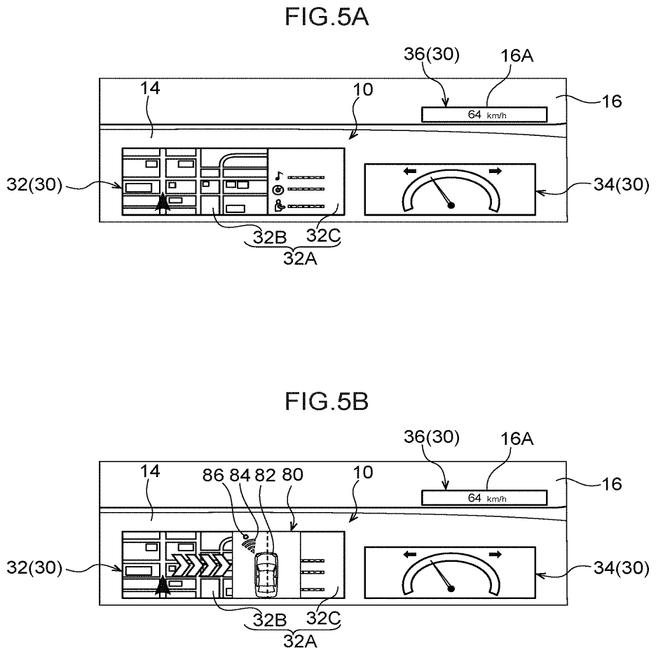

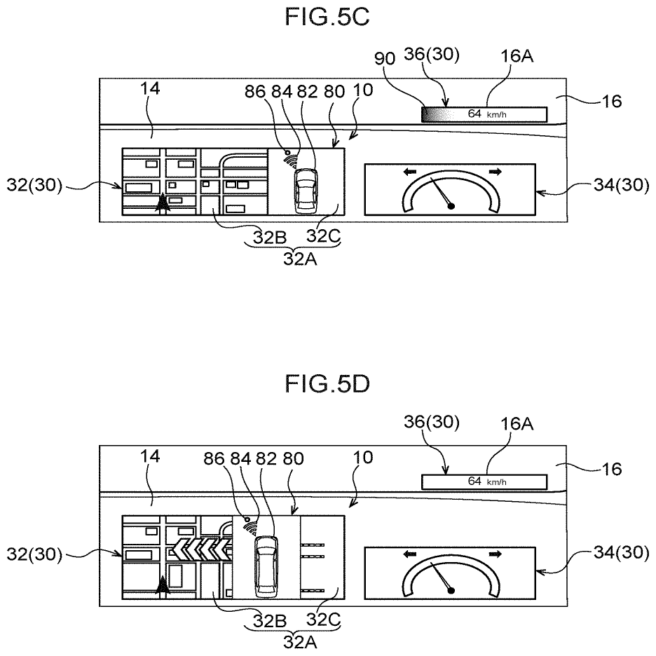

Explanation follows regarding a display system 10 including a display control device 20 of an exemplary embodiment, with reference to the drawings. Note that in FIG. 1 and in FIG. 5A to FIG. 5D, reference to upward, downward, left, and right directions in the context of display of respective display devices 30 refers to these directions as seen from the perspective of a driver looking at the display devices 30.

Basic Configuration

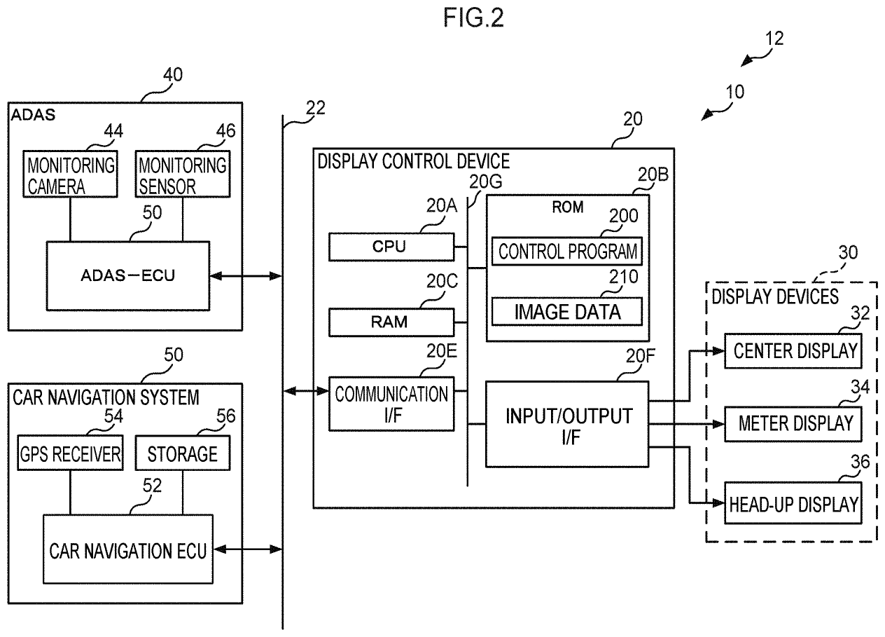

As illustrated in FIG. 1 and FIG. 2, the display system 10 of the present exemplary embodiment is installed in a vehicle 12. In addition to the display control device 20, the display system 10 is configured including the display devices 30, an advanced driver assistance system (ADAS) 40, and a car navigation system 50.

The display control device 20, an ADAS electronic control unit (ECU) 42 of the ADAS 40, and a car navigation ECU 52 of the car navigation system 50 are connected together through an external bus 22.

Display Devices

The display devices 30 are configured including a center display 32, a meter display 34, and a head-up display 36.

As illustrated in FIG. 1, the center display 32 is a liquid crystal display provided at a vehicle width direction center of a dashboard 14. The center display 32 includes an overall screen display region 32A, of which approximately the left two thirds is an information region 32B and approximately the right one third is a notification region 32C. The information region 32B displays images relating to the car navigation system 50, for example a map image indicating a current position of the vehicle 12, or an image guiding the vehicle 12 toward a destination. The notification region 32C displays images relating to an audio function of the car navigation system 50, and an interruption image 80, described later. The center display 32 is an example of a display device visible to the driver of the vehicle 12.

The meter display 34 is a liquid crystal display provided to the dashboard 14 in front of a driver sitting in a seat, so as to be on the vehicle width direction right side of the adjacent center display 32. The meter display 34 displays information relating to travel of the vehicle 12, including the vehicle speed, engine revolution speed, and travel distance, as well as information relating to states of the vehicle 12, including warning lamps and light operation status.

The head-up display 36 is on the vehicle upper side of the meter display 34, and is a projection device including a projection screen 16A on a front windshield 16. The projection screen 16A of the head-up display 36 is situated on a line of gaze of the driver when performing driving operations. The head-up display 36 displays high priority information out of information to be reported to the driver, such as the vehicle speed, the direction of progress of the vehicle 12, an operation position of a steering switch, and the like.

ADAS

As illustrated in FIG. 2, in addition to the ADAS-ECU 42, the ADAS 40 is configured including monitoring cameras 44 serving as imaging devices, and monitoring sensors 46.

The monitoring cameras 44 are provided at various locations of the vehicle 12, including at an upper portion of a front windshield, a front grille, lower portions of door mirrors, a tailgate, and the like, and capture images externally from the vehicle 12. The monitoring sensors 46 are a set of sensors that detect peripheral information relating to the periphery of the vehicle 12. The monitoring sensors 46 include plural millimeter-wave radars provided at various locations on the vehicle body to detect obstacles in the surroundings of the vehicle 12. Note that the monitoring sensors 46 may also include laser imaging detection and ranging (LIDAR) to scan a predetermined range.

The ADAS-ECU 42 has a function of providing the peripheral information to other ECUs, and controlling steering and braking as required. The ADAS-ECU 42 is configured including a central processing unit (CPU), read only memory (ROM), random access memory (RAM), a communication interface (I/F), an input/output interface (I/F), and the like.

The ADAS-ECU 42 generates peripheral information based on detection information received from the respective monitoring sensors 46 installed around the periphery of the vehicle 12. Note that the ADAS-ECU 42 may generate peripheral information based on captured information from the monitoring cameras 44 installed at various locations of the vehicle 12 in addition to the detection information from the monitoring sensors 46. The ADAS-ECU 42 also determines whether or not the vehicle 12 and an obstacle are approaching one another based on the generated peripheral information. Here, “cases in which the vehicle 12 and an obstacle are approaching one another” include both cases in which the obstacle is approaching the vehicle 12 and cases in which the vehicle 12 is approaching the obstacle. In cases in which the ADAS-ECU 42 has determined that the vehicle 12 and an obstacle are approaching one another, the ADAS-ECU 42 transmits approach information, this being information to indicate this approach, to the display control device 20.

Car Navigation System

In addition to the car navigation ECU 52, the car navigation system 50 is configured including a GPS receiver 54 and storage 56. The car navigation system 50 of the present exemplary embodiment includes both a car navigation function and an audio function, as a minimum.

The GPS receiver 54 measures the current position of the vehicle 12 by receiving GPS signals from plural GPS satellites.

The storage 56 is configured by a hard disk drive (HDD) or a solid state drive (SSD), and stores map data and music data.

The car navigation ECU 52 includes functionality to generate a travel route to the destination of the vehicle 12, guide the vehicle 12 to the destination based on position information, and the like. The car navigation ECU 52 is configured including a CPU, ROM, RAM, a communication I/F, an input/output I/F, and the like.

The car navigation ECU 52 of the present exemplary embodiment sets a route to the destination based on destination information input using the center display 32 that also serves as a touch panel, the map data stored in the storage 56, and the like. The car navigation ECU 52 also displays a map indicating the current position of the vehicle 12 or a screen to guide the vehicle 12 to the destination on the center display 32, based on the position information received from the GPS receiver 54.

Display Control Device

The display control device 20 is configured including a central processing unit (CPU) 20A, read only memory (ROM) 20B, random access memory (RAM) 20C, a communication interface (I/F) 20E, and an input/output interface (I/F) 20F. The CPU 20A, the ROM 20B, the RAM 20C, the communication I/F 20E, and the input/output I/F 20F are connected together so as to be capable of communicating with each other through an internal bus 20G.

The CPU 20A is a central processing unit that executes various programs and controls various sections. Namely, the CPU 20A reads programs from the ROM 20B and executes these programs using the RAM 20C as a workspace. The CPU 20A is an example of a processor.

The ROM 20B stores various programs and various data. The ROM 20B of the present exemplary embodiment is stored with a control program 200 and image data 210. The control program 200 is a program for performing image display processing, described later. The image data 210 includes stored data of images of icons for display on the respective display devices 30, as well as a vehicle image 82, level images 84, and the like for display on the center display 32.

The RAM 20C serves as a workspace that temporarily stores programs or data.

The communication I/F 20E is an interface for connecting to the ADAS-ECU 42 and the car navigation ECU 52. A controller area network (CAN) communication protocol is employed for this interface. The communication I/F 20E is connected to the external bus 22. Note that the communication method of the communication I/F 20E is not limited to CAN, and a LAN protocol such as Ethernet (registered trademark) may be adopted therefor.

The input/output I/F 20F is an interface for communicating with the respective display devices 30 including the center display 32, the meter display 34, and the head-up display 36.

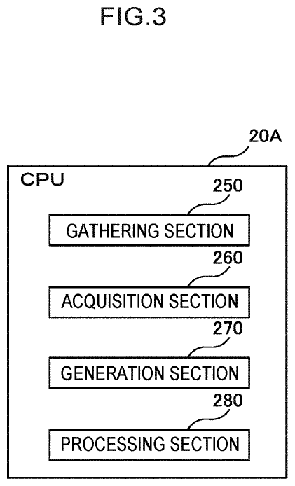

FIG. 3 is a block diagram illustrating an example of functional configuration of the display control device 20. This functional configuration is implemented by the CPU 20A reading and executing the control program 200 stored in the ROM 20B. The CPU 20A of the present exemplary embodiment executes the control program 200 so as to function as a gathering section 250, an acquisition section 260, a generation section 270, and a processing section 280.

The gathering section 250 has a function of gathering captured images capturing the vehicle 12 exterior from the monitoring cameras 44. Specifically, the gathering section 250 acquires captured images captured by the respective monitoring cameras 44 from the ADAS 40.

The acquisition section 260 has a function of acquiring approach information indicating that the vehicle 12 and an obstacle are approaching one another. The approach information is transmitted to the display control device 20 in cases in which the ADAS 40 has determined an obstacle to be present within a detection range of the monitoring sensors 46 based on the peripheral information relating to the periphery of the vehicle 12.

The approach information includes proximity information indicating the proximity of the approach between the vehicle 12 and the obstacle. The acquisition section 260 is also capable of judging the direction of the obstacle by identifying which monitoring sensor(s) 46 out of the plural monitoring sensors 46 detected the obstacle.

The generation section 270 has a function of generating an image to interrupt the notification region 32C of the center display 32, namely an interruption image 80 including a captured image relating to the obstacle approaching the vehicle 12 and an image indicating the direction of the obstacle relative to the vehicle 12 and the proximity of its approach. As illustrated in FIG. 5C, specifically the interruption image 80 includes a bird's eye vehicle image 82 representing the vehicle 12, a level image 84 indicating the approach proximity of the obstacle, and a target image 86 of the obstacle itself.

The vehicle image 82 is an image stored in the image data 210, and is a graphic representation of the vehicle 12 as if viewed from above. The level image 84 is a spreading fan-shaped image stored in the image data 210, and includes arcs corresponding to the direction of an obstacle relative to the vehicle 12, with a larger image being employed the closer the approach between the vehicle 12 and the obstacle. In the interruption image 80, a surrounding portion excluding the vehicle image 82 and the level image 84 can be obtained by merging respective captured images from the plural monitoring cameras 44 provided to various locations of the vehicle 12 using a known method. The display position of the level image 84 relative to the vehicle image 82 is equivalent to the direction of the obstacle relative to the vehicle 12. The generation section 270 of the present exemplary embodiment generates the interruption image 80 in cases in which the acquisition section 260 has acquired approach information from the ADAS 40.

The processing section 280 executes processing to display images on the respective display devices 30. The processing section 280 of the present exemplary embodiment performs processing to display the interruption image 80 generated by the generation section 270 in the notification region 32C of the center display 32.

In cases in which an approach between the vehicle 12 and an obstacle has been detected as a result of the acquisition section 260 acquiring approach information from the ADAS 40, the processing section 280 displays the interruption image 80 in the notification region 32C. More specifically, detection of an approach between the vehicle 12 and an obstacle acts as a stimulus for the processing section 280 to execute an animation on the center display 32 to cause the interruption image 80 to slide into the notification region 32C from a direction corresponding to the direction of the obstacle relative to the vehicle 12.

Moreover, when acquisition of the approach information by the acquisition section 260 ends and the approach between the vehicle 12 and the obstacle is therefore no longer detected, the processing section 280 moves the interruption image 80 out of the notification region 32C. More specifically, detection of the approach between the vehicle 12 and the obstacle ending acts as a stimulus for the processing section 280 to execute an animation on the center display 32 to cause the interruption image 80 displayed in the notification region 32C to slide out in a direction corresponding to the direction of the obstacle relative to the vehicle 12.

Control Flow

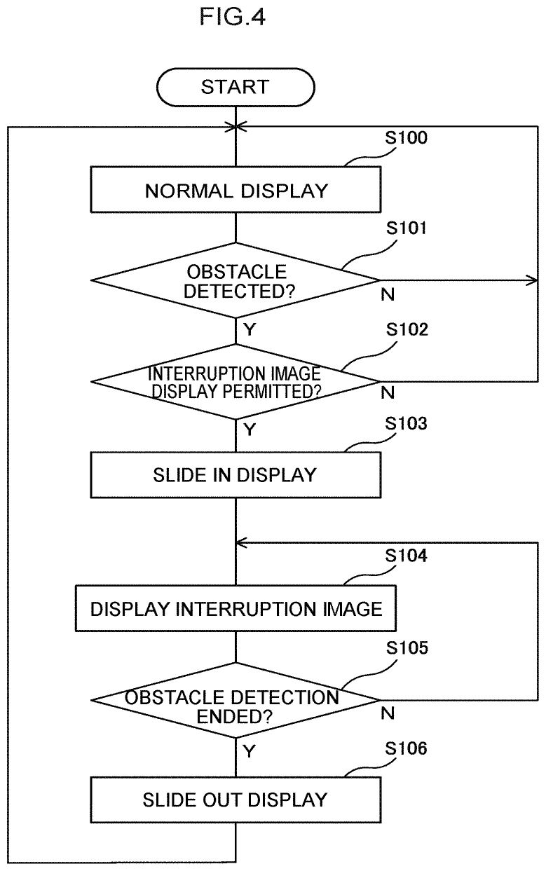

Explanation follows regarding a flow of image display processing executed for the center display 32 by the display control device 20 of the present exemplary embodiment, with reference to the flowchart illustrated in FIG. 4 and the example screens illustrated in FIG. 5A to FIG. 5D. FIG. 4 and FIG. 5A to FIG. 5D illustrate examples of a flow of processing in a case in which an obstacle has been detected to the front left of the vehicle 12.

At step S100 in FIG. 4, the CPU 20A executes normal display on the center display 32. As illustrated in FIG. 5A, during normal display a map image generated by the car navigation system 50 is displayed in the information region 32B, and images relating to the audio function are displayed in the notification region 32C.

At step S101 in FIG. 4, the CPU 20A determines whether or not an obstacle has been detected. Namely, the CPU 20A determines whether or not the vehicle 12 and an obstacle are approaching one another based on received approach information. In cases in which the CPU 20A determines that an obstacle has been detected, processing proceeds to step S102. On the other hand, in cases in which the CPU 20A determines that an obstacle has not been detected, processing returns to step S100.

At step S102, the CPU 20A determines whether or not display of the interruption image 80 in the notification region 32C is permitted. In cases in which the CPU 20A determines that display of the interruption image 80 in the notification region 32C is permitted, processing proceeds to step S103. On the other hand, in cases in which the CPU 20A determines that display of the interruption image 80 in the notification region 32C is not permitted, processing returns to step S100. Note that examples of cases in which display of the interruption image 80 is not permitted include cases in which settings of the car navigation system 50 have been set to block the interruption image 80, and cases in which the vehicle 12 is completely stationary and the side brake has been actuated.

At step S103, the CPU 20A executes an animation to cause the interruption image 80 to slide in. Specifically, the CPU 20A executes an animation to cause the interruption image 80 to fade in at the right side of the information region 32B, and then cause the interruption image 80 to slide into the notification region 32C. Thus, as illustrated in FIG. 5B, the driver is able to recognize the interruption image 80 as entering the notification region 32C from the left side, this corresponding to the direction of the obstacle.

At step S104 in FIG. 4, the CPU 20A executes interruption display to display the interruption image 80 in the notification region 32C. Namely, as illustrated in FIG. 5C, the CPU 20A continues to display the interruption image 80 after the interruption image 80 has slid into the notification region 32C.

The CPU 20A also displays a level bar image 90 indicating a detection level of the monitoring sensors 46 in the head-up display 36. When this is performed, the level bar image 90 is displayed on the head-up display 36 in a direction corresponding to the direction of the obstacle. Namely, in the illustrated example, the level bar image 90 is displayed at a left edge of the projection screen 16A of the head-up display 36. The level bar image 90 indicates the approach proximity of the obstacle using light and dark, changes in hue, or color density. The level bar image 90 may increase in width or exaggerate the hue as the approach proximity increases.

At step S105 in FIG. 4, the CPU 20A determines whether or not detection of the obstacle has ended. In cases in which the CPU 20A determines that detection of the obstacle has ended, processing proceeds to step S106. On the other hand, in cases in which the CPU 20A determines that detection of the obstacle has not ended, processing returns to step S104. Namely, the CPU 20A continues to display the interruption image 80 in the notification region 32C.

At step S106, the CPU 20A executes an animation to cause the interruption image 80 to slide out. Specifically, the CPU 20A executes an animation to cause the interruption image 80 to slide out from the notification region 32C. Thus, as illustrated in FIG. 5D, the driver is able to recognize the movement of the interruption image 80 from the notification region 32C toward the left side, this being the side corresponding to the direction of the obstacle.

Processing then returns to step S100. Namely, the CPU 20A causes the interruption image 80 to fade out after moving to the right side of the information region 32B, and returns to performing normal display illustrated in FIG. 5A, in which the map image is displayed in the information region 32B and images relating to the audio function are displayed in the notification region 32C.

### Summary of the Exemplary Embodiment

In the display control device 20 of the present exemplary embodiment, the gathering section 250 gathers the captured images captured by the monitoring cameras 44, and in cases in which an approach between the vehicle 12 and an obstacle has been detected based on the peripheral information, the generation section 270 generates the interruption image 80 for display on the center display 32. The interruption image 80 includes the bird's eye vehicle image 82 of the vehicle 12 and the level image 84 indicating the direction of the obstacle relative to the vehicle 12 and the approach proximity of the obstacle.

Moreover, in the display control device 20, the processing section 280 performs processing to display the interruption image 80 in the notification region 32C, this being part of the display region 32A of the center display 32. As illustrated in FIG. 5C, the display control device 20 of the present exemplary embodiment notifies the driver with both the target image 86 of the obstacle, and the level image 84 indicating the direction from which the obstacle has appeared. The driver is thus able to easily ascertain the direction of the obstacle relative to the vehicle 12.

In particular, in the present exemplary embodiment, in cases in which the approach of an obstacle relative to the vehicle 12 has been detected, the bird's eye vehicle image 82 of the vehicle 12 is displayed in the interruption image 80, enabling the driver to accurately ascertain the direction in which the obstacle is present relative to the vehicle 12. Moreover, the present exemplary embodiment is capable of indicating the approach proximity of the obstacle using the level image 84, thus intuitively communicating a sense of the distance to the obstacle to the driver.

In the display control device 20 of the present exemplary embodiment, when an approach between the vehicle 12 and an obstacle has been detected, processing is executed to cause the interruption image 80 to slide into the notification region 32C. The present exemplary embodiment is thus capable of intuitively communicating to the driver both the fact that the obstacle is approaching and the direction from which the obstacle is approaching.

Moreover, in the display control device 20 of the present exemplary embodiment, when detection of the approach between the vehicle 12 and the obstacle has ended, processing is executed to cause the interruption image 80 to slide out from the notification region 32C. The present exemplary embodiment is thus capable of intuitively communicating to the driver that the obstacle has moved away from the vehicle 12 or that danger has been averted.

Note that FIG. 4 and FIG. 5A to FIG. 5D described above illustrate an example in which an obstacle is detected at the front left of the vehicle 12. However, similar processing is executed in cases in which an obstacle is detected in another direction. For example, in a case in which an obstacle has been detected at the front right of the vehicle 12, the interruption image 80 slides in from the right side of the notification region 32C, and when detection ends, the interruption image 80 slides out toward the right side of the notification region 32C. In such cases, since the display region 32A is not present at the right side of the notification region 32C, the interruption image 80 gradually appears from the right side of the notification region 32C, and the interruption image 80 gradually disappears toward the right side of the notification region 32C. Similarly, in cases in which an obstacle has been detected at the front or rear of the vehicle 12, the interruption image 80 may be made to slide in and slide out along a vertical direction.

### OTHER REMARKS

Although the present exemplary embodiment describes a case in which processing is executed such that the interruption image 80 is displayed in the notification region 32C when an approach between the vehicle 12 and an obstacle has been detected, the “event notifiable to a driver” are not limited thereto. For example, the “event notifiable to a driver” may include cases in which the vehicle 12 approaches another object, such as another vehicle, bicycle, pedestrian, or the like, cases in which the vehicle is close to straying from its lane, and cases in which a new road sign appears or a new restriction comes into effect. In the present exemplary embodiment, processing may be executed to display the interruption image 80 in the notification region 32C in cases in which an event notifiable to a driver has been detected.

In the present exemplary embodiment, in cases in which the ADAS 40 has determined an obstacle to be present based on the peripheral information from the monitoring sensors 46, the approach information is transmitted to the display control device 20. However, there is no limitation thereto. For example, the display control device 20 may acquire the peripheral information directly from the ADAS 40 in order to determine the presence of an obstacle based on this acquired peripheral information.

Although the vehicle image 82 of the interruption image 80 of the present exemplary embodiment is a bird's eye image of the vehicle 12, there is no limitation thereto, and the vehicle image 82 may be a captured image of the vehicle 12 taken by one of the monitoring cameras 44.

Although the slide speed of the interruption image 80 is fixed in the present exemplary embodiment, the slide speed may be changed in response to the approach proximity, namely in response to a notification urgency level of the event notifiable to a driver. For example, in cases in which an obstacle has been detected at a stage at which there is still a considerable distance between the vehicle 12 and the obstacle, the interruption image 80 may be made to slide in slowly, whereas in cases in which an obstacle has been detected at a stage at which the vehicle 12 and the obstacle are already close to each other, the interruption image 80 may be made to slide in quickly. Namely, the slide speed of the interruption image 80 may be made faster the closer the distance to the obstacle when an obstacle has been detected. Alternatively, the speed and manner of sliding may be modified according to the type of obstacle, for example according to whether the obstacle is a fixed object or a moving object.

Note that the various processing executed by the CPU 20A reading software (a program) in the exemplary embodiment described above may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The processing described above may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

Moreover, in the exemplary embodiments described above, explanation has been given in which the program is in a format stored in advance (installed) on a computer-readable non-transitory storage medium. For example, the control program 200 of the display control device 20 is stored in advance in the ROM 20B. However, there is no limitation thereto, and the respective programs may be provided in a format recorded on a non-transitory storage medium such as a compact disc read only memory (CD-ROM), digital versatile disc read only memory (DVD-ROM), or universal serial bus (USB) memory. Alternatively, the program may be provided in a format to be downloaded from an external device over a network.

The processing flow described in the above exemplary embodiment is merely an example thereof, and unnecessary steps may be removed, new steps may be added, and the processing sequence may be changed within a range not departing from the spirit thereof.

What is claimed is:

1. A display control device comprising a processor, the processor being configured to:
gather a captured image from an imaging section that captures images of outside a vehicle;
in a case in which an event notifiable to a driver of the vehicle has been detected based on peripheral information relating to a periphery of the vehicle, generate an interruption image including a captured image relating to the event and information indicating a direction in which the event has arisen relative to the vehicle; and
perform processing to display the generated interruption image in a notification region configuring part of a display region of a display device that is visible to the driver of the vehicle.

2. The display control device of claim 1, wherein the processor is further configured to display the interruption image on the display device, so as to slide into the notification region from the direction of the event in a case in which the event has been detected based on the peripheral information.

3. The display control device of claim 2, wherein the processor is further configured to make a slide speed of the interruption image faster, as a notification urgency level of the event increases.

4. The display control device of claim 2, wherein the processor is further configured to perform display on the display device, such that the interruption image being displayed in the notification region slides out toward the direction of the event in a case in which detection of the event based on the peripheral information has ended.

5. The display control device of claim 1, wherein:
the event is an approach of an obstacle relative to the vehicle; and
the interruption image includes a bird's eye vehicle image representing the vehicle and a level image indicating an approach proximity of the obstacle.

6. The display control device of claim 5, further comprising a head-up display in addition to the display device, the head-up display including a projection screen situated on a line of gaze of the driver, wherein:
in a case in which the event has been detected based on the peripheral information, the processor is further configured to display a level bar image on a side of the head-up display corresponding to the direction of the event, the level bar image indicating the approach proximity of the obstacle using light and dark, changes in hue, or color density.

7. A display control method comprising:
gathering processing to gather a captured image from an imaging section that captures images of outside a vehicle;
generation processing to, in a case in which an event notifiable to a driver of the vehicle has been detected based on peripheral information relating to a periphery of the vehicle, generate an interruption image including a captured image relating to the event and information indicating a direction in which the event has arisen relative to the vehicle; and
interruption processing to perform processing to display the generated interruption image in a notification region configuring part of a display region of a display device that is visible to the driver of the vehicle.

8. A non-transitory storage medium storing a program executable by a computer to perform processing, the processing comprising:
gathering processing to gather a captured image from an imaging section that captures images of outside a vehicle;
generation processing to, in a case in which an event notifiable to a driver of the vehicle has been detected based on peripheral information relating to a periphery of the vehicle, generate an interruption image including a captured image relating to the event and information indicating a direction in which the event has arisen relative to the vehicle; and
interruption processing to perform processing to display the generated interruption image in a notification region configuring part of a display region of a display device that is visible to the driver of the vehicle.
